(19) United States
(12) Patent Application Publication
(10) Pub. No.: US 2009/0052728 A1
(43) Pub. Date: Feb. 26, 2009

(54) Method and device for displaying images

(76) Inventors: Laurent Blonde, Thorigne-Fouillard (FR); Olivier Le Meur, Talensac (FR); Jonathan Kervec, Paimpont (FR)

Correspondence Address: Joseph J. Laks;Thomson Licensing LLC, 2 Independence Way, Patent Operations, PO Box 5312, PRINCETON, NJ, 08543, US

(21) Appl. No.: 11/991,189

(22) PCT Filed: Sep. 5, 2006
(86) PCT No.: PCT/EP2006/066039

§ 371 Date: Feb. 28, 2008

(30) Foreign Application Priority Data
Sep. 8, 2005 (FR) 0552704

(51) Int. Cl. G06K 9/00

(52) U.S. Cl. 382/100

(57) ABSTRACT

The present invention relates to a method and a device for displaying images aimed at combating the copying of images by filming during their display, for example by a camcorder in a cinema hall. It is known to modulate the luminance of the pixels of a pattern around the value to be displayed at a high frequency which renders the pattern invisible to the human eye but which generates artefacts on the sequence shot by the camcorder. This pattern is commonly called an anti-copy pattern. According to the invention, it is proposed to increase the hindrance generated by this modulation by varying the amplitude of the modulation of the pixels of the anti-copy pattern as a function of their membership or non-membership in a zone of interest of the sequence.

The present invention relates to a method and a device for displaying images.

Visual contents, whether they involve static or moving images, are generally creations which benefit from exclusivity guarantees related to copyright. Their reproduction is in general authorized only in a strictly defined framework which allows the remuneration of the authors and of their beneficiaries. The possibility of acquiring them illegally and free of charge currently constitutes an obstacle to the development of digital cinema and digital video display. Specifically, a film acquired in this way can be of very good quality and can readily be duplicated and distributed. It can then feed into film distribution circles that do not adhere to copyright payments, thereby representing a shortfall which has to be made up by firms holding these rights. For the moment, these firms prefer therefore to stay with traditional display means, fearing to take more risks with the new technologies.

There nevertheless exist numerous systems for preventing illegal copies by sufficiently impairing their quality, thus rendering them unusable.

For example, patent application EP 1 237 369 relates to a method and a device aimed at combating the copying of images by filming during their display, for example by a camcorder in a cinema hall. With this aim, it is proposed to modulate the luminance of the pixels of a pattern around the value to be displayed at a high frequency which renders the pattern invisible to the human eye but which generates artefacts on the sequence shot by the camcorder. This pattern is commonly called a watermark or anti-copy pattern.

The shape of the pattern is determined so as for example to inscribe messages of the type “ILLEGAL COPY” in the images displayed by the camcorder.

So that the pattern is invisible to the naked eye, the modulation consists in alternating images in which the pattern is light with images in which it is dark, the average intensity of the pattern over several images corresponding to that to be displayed in the images in the absence of any pattern. During the display of these images, the eye carries out an integration and in fact perceives the average intensity.

Another method consists in modulating the colour of the pixels of the pattern without modifying their luminance. The colour of the pixels of the pattern is modulated around the colour to be displayed at a high frequency which renders the pattern invisible to the human eye. This method is then based on colour fusion. It is described in great detail in international patent application WO 05/027529.

In a general manner, this temporal modulation aims to distribute over time an item of information which is received at a given instant t. This information is generally related to the video and may be as indicated previously the luminance or the colour. The temporal distribution is done at instants separated by “frame” or “sub-frame” times.

However, it has been noted that, for moving scenes, the anti-copy pattern appears to the naked eye while it does not appear on a static image modulated in the same manner. Specifically, as the eye has a tendency to follow the motion in the image, the light pattern is no longer aligned with the dark pattern so that the temporal integration is no longer done correctly. Let us take the example of a modulation creating a deficit of luminance for a pixel P of the pattern in a first image and a complementary excess of luminance for the same pixel in a second image. If the eye does not move, it sums the luminances of these two pixels and then perceives the average luminance value. The perception of the eye is then correct. If the eye moves, the pixel P in the first image is not integrated by the same retinal zone of the eye as this same pixel in the second image. The visual sum between these two pixels is no longer correct and the pattern is then detected by the eye.

To solve this problem, it is possible to make the pattern move in accordance with the motion of the eye in such a way that the latter integrates the video information pertaining to one and the same pixel in the two successive images displayed. This technique of motion compensation of the anti-copy pattern makes it possible to limit the defects and to improve the quality of the processing.

An aim of the invention is to propose a method and a device making it possible to improve the modulation process even further.

According to the invention, it is proposed to adjust the amplitude of the temporal modulation of the pixels of the anti-copy pattern as a function of their membership or non-membership of a zone of interest of the sequence so as to increase the hindrance of the viewer when he views an illegal copy.

The present invention relates to a method of image processing intended to display at least one anti-copy pattern in a sequence of source images, each source image comprising a plurality of pixels arranged in rows and columns and the said pattern comprising a set of pixels selected from the said image, each pixel having a predetermined video information item in each of the source images, the said method comprising a step of modulation for temporally modulating the video information of each pixel of the pattern around its predetermined video information so as to be invisible to the human eye and create artefacts when the said images are copied by filming during their display. According to the invention, prior to the said step of modulation, the method comprises a step of detection of the zones of interest in the sequence of source images. The amplitude of the modulation of the video information of a pixel of the pattern around its predetermined video information is then adjusted as a function of its membership of a zone of interest.

According to a first embodiment, the amplitude of the temporal modulation of the pattern is larger in the zones of non-interest than in the zones of interest so as to reduce the ocular perception of these latter. The anticopy pattern then appearing more sharply in the zones of non-interest of the illegal image acquired, it becomes a zone of interest in the psycho-visual sense, then attracting the eye outside of the real zone of interest.

According to another preferred embodiment, the amplitude of the temporal modulation of the pattern is conversely lower in the zones of non-interest with respect to the zones of interest so as to reduce the disturbances in peripheral vision that could be engendered by the first embodiment.

Advantageously, in this embodiment, the amplitude of the modulation of the pixels of the pattern belonging to zones of non-interest decreases as the distance separating the pixels to be modulated and the zone of interest increases.

Preferably, the method is supplemented with a step of estimation of the motion in the images of the said sequence so as to motion compensate the pattern according to the estimated motion and reduce the possible hindrance introduced by poor temporal integration of the pattern in a moving scene.

An alternative to the step of motion estimation consists in detecting the static zones in the sequence of source images and in selecting the pixels to be modulated temporally from among the pixels of the static zones detected.

Whatever the embodiment, the temporally modulated video information can be the luminance and/or the chrominance of the pixel.

The invention also relates to a device for image processing intended to display at least one anti-copy pattern in a sequence of source images, each source image comprising a plurality of pixels arranged in rows and columns and the said pattern comprising a set of pixels selected from the said image, each pixel having a predetermined video information item in each of the source images, the said device comprising a modulation circuit for temporally modulating the video information of each pixel of the pattern around its predetermined video information so as to be invisible to the human eye and create artefacts when the said images are copied by filming during their display. According to the invention, this device further comprises a circuit for detecting the zones of interest in the sequence of source images. The modulation circuit then modulates the video information of the pixels of the pattern with an amplitude which depends on the membership of the said pixels in a zone of interest.

The invention will be better understood on reading the description which will follow, given by way of non-limiting example, and with reference to the appended drawings among which:

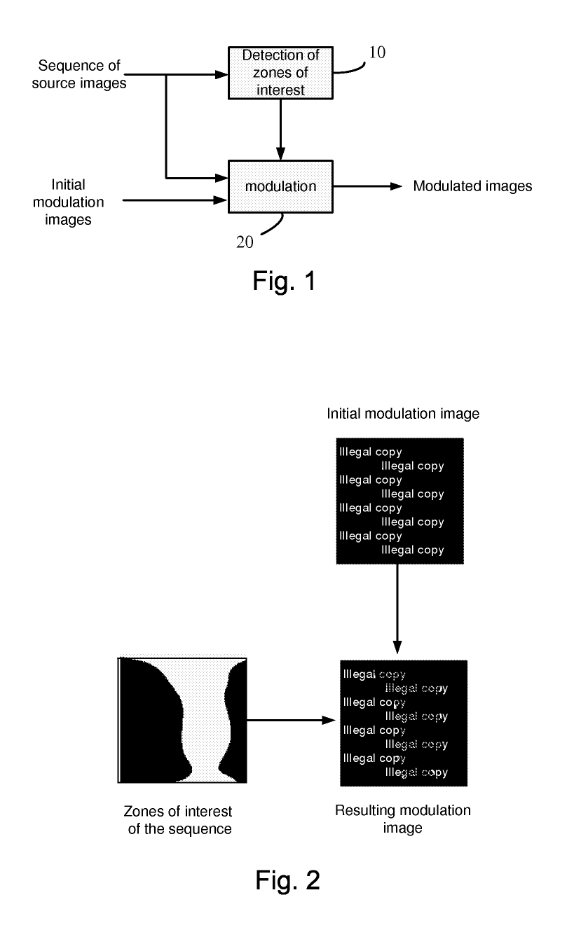

FIG. 1 diagrammatically represents the principle of the method of the invention,

FIG. 2 illustrates a first embodiment of the method of the invention,

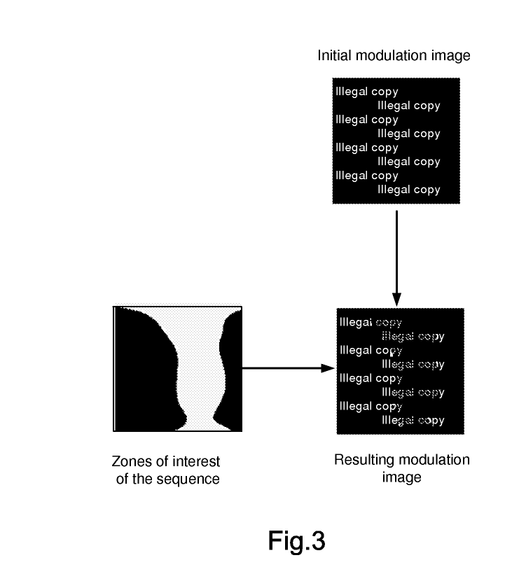

FIG. 3 illustrates a second embodiment of the method of the invention,

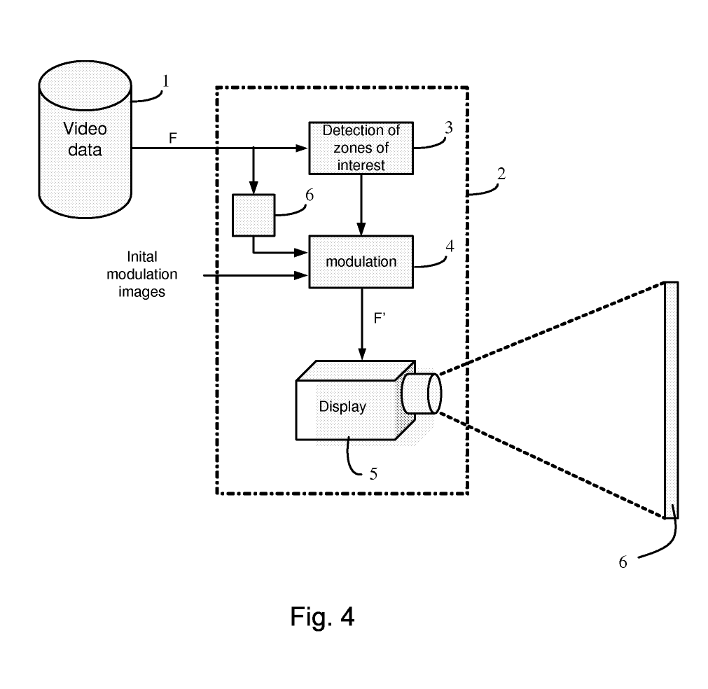

FIG. 4 represents a display device implementing the method of the invention,

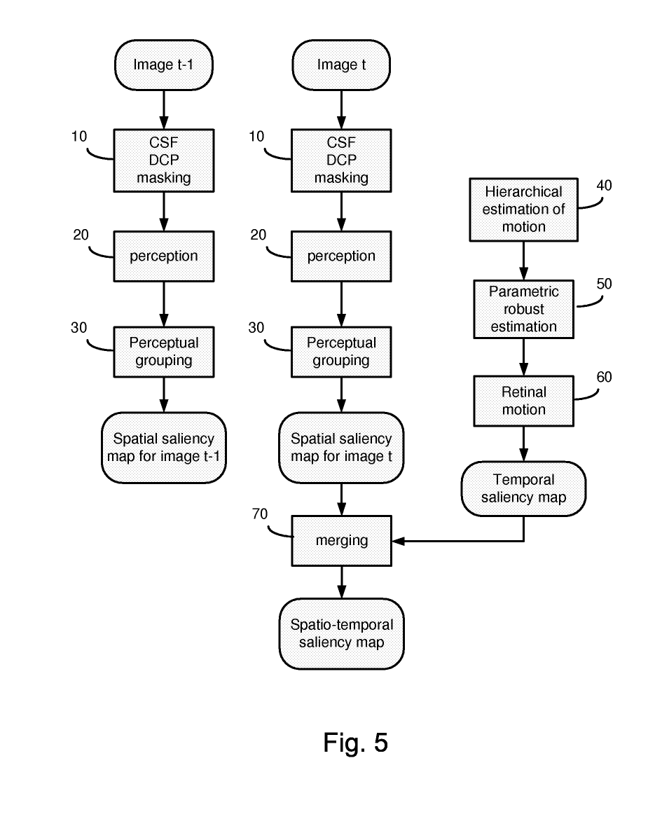

FIG. 5 diagrammatically represents the generation of maps of spatio-temporal saliency of a sequence of images,

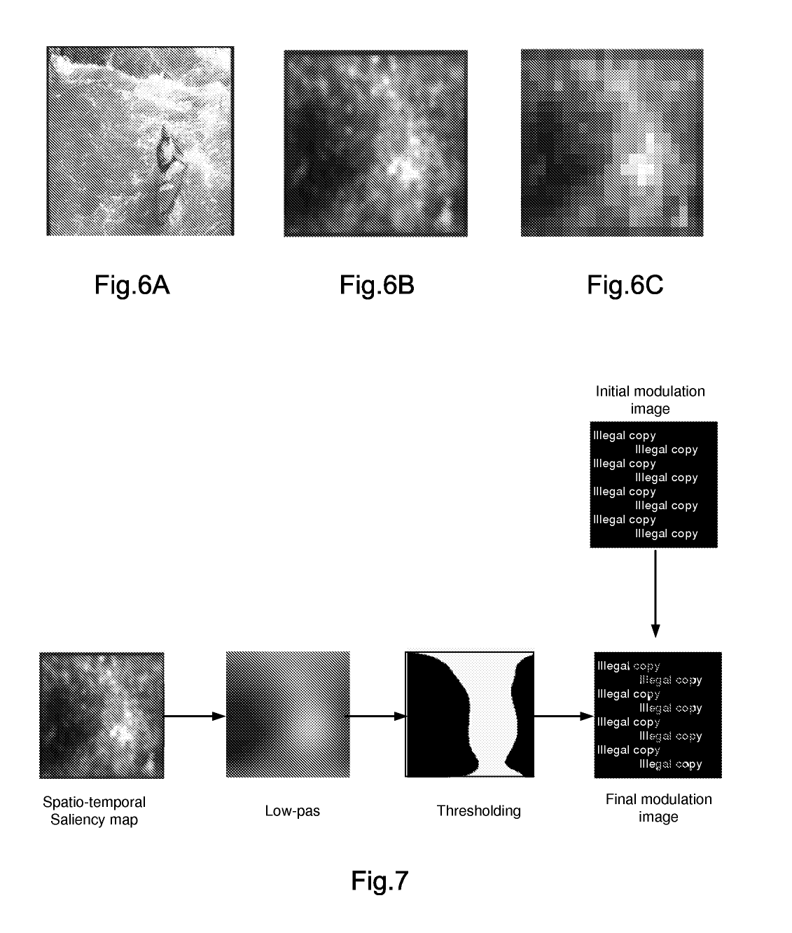

FIGS. 6A to 6C respectively represent a source image representative of a sequence of images, a first spatio-temporal saliency map of the sequence and a second spatio-temporal saliency map of the sequence processed per macroblock,

FIG. 7 illustrates the generation of zones of interest at part of a spatio-temporal saliency map, and

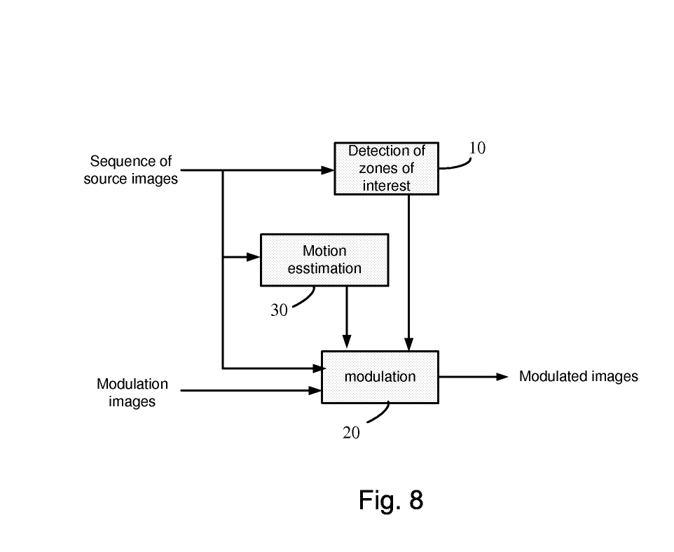

FIG. 8 diagrammatically represents the method of the invention with a step of motion estimation.

The description below will be given within the framework of images coded in digital form, but the invention is naturally not limited to this type of coding. In this framework, the image or the images to be displayed are described by data stored on an information medium, such as an optical disk, a hard disk or a magnetic tape. These data can also originate from a transmission channel (RF, satellite, cable or ADSL for example).

According to the method of the invention, it is proposed to perform a step of detection of the zones of interest in the sequence of source images and to adapt the amplitude of the temporal modulation of the luminance and/or chrominance of the pixels of the anti-copy pattern as a function of their membership or non-membership of a zone of interest. The general principle of the method of the invention is illustrated by FIG. 1. A detection of zones of interest 10 is operated in the sequence of source images. The result of this detection is thereafter used to modify the modulation images initially envisaged for temporally modulating (step 20) the sequence of source images. The video information which is temporally modulated can be the luminance and/or the chrominance. Subsequently in the description, we shall consider that the modulation images modulate the luminance (and not the colour) of the pixels corresponding to the anti-copy pattern in the source images at a high frequency which renders the pattern invisible to the human eye. The luminance of these pixels of the pattern is modulated with a certain amplitude around the luminance value to be displayed initially. On a first image, the luminance of these pixels is for example increased by +20 and in the following image, it is reduced by −20. According to the invention, the amplitude of the modulation, which in this example is 40, is different according to whether or not the pixel belongs to a zone of interest of the sequence of source images.

According to a first embodiment, the amplitude of the temporal modulation of the pattern is larger in the zones of non-interest than in the zones of interest. This then reduces in the fraudulently copied sequence of images the ocular perception of the zones of interest of the sequence. Moreover, the anticopy pattern appears sharper in the zones of non-interest of the fraudulent images and may exhibit a blinking. It then becomes a hindrance since it itself becomes a zone of interest in the psycho-visual sense, attracting the eye outside of the real zone of interest.

This embodiment is illustrated by FIG. 2. The upper part of the figure shows an initial modulation image containing an anti-copy pattern in which all the pixels of the pattern are modulated with the same amplitude. In this example, the anti-copy pattern consists of the message “illegal copy” repeated several times. The sequence of source images moreover comprises a zone of interest represented white in the image of the left lower part of the figure. The modulation image which is used for the implementation of this first embodiment is then the image represented in the right lower part of the figure. The parts of the pattern belonging to the zone of interest are hatched to show that the amplitude of the modulation is lower in this zone than in the zone of non-interest of the sequence where the pattern is displayed white.

In this embodiment, it is conceivable not to modulate the whole anti-copy pattern (modulation with a zero amplitude) in the zones of interest.

This embodiment exhibits a drawback however. In peripheral vision, the eye (and more particularly the zone of the retina enclosing the rods) is sensitive to changes of luminosity and to motions. As, in this embodiment, the eye is centered on the zones of interest, it is at risk of being hindered by the changes of luminance or of chrominance that are generated by the strong modulation outside of the zones of interest.

So as not to have this hindrance in peripheral vision, a second embodiment has been defined. According to this embodiment, the amplitude of the temporal modulation of the pattern is reduced in the zones of non-interest with respect to the zones of interest. This embodiment is illustrated by FIG. 3. This figure shows that the amplitude of the modulation of the pixels of the anti-copy pattern is lower for the pixels of the pattern belonging to the zone of interest (pattern in grey) than for the pixels of the pattern not belonging to the zone of interest (pattern in white).

Advantageously, in this second embodiment, it is possible to use a progressive modulation which consists in making the amplitude of the modulation decrease as we move away from the zone or zones of interest of the sequence.

FIG. 4 illustrates a display device 2 implementing one or the other of these embodiments. The display system 2 receives these data in the form of a source stream F which represents the sequence of images to be displayed. It comprises a detection circuit 3 for detecting the zones of interest in the sequence of images and a modulation circuit 4 for temporally modulating the image sequence with the aid of modulation images. The modulation is performed in accordance with the method described previously in the modulation circuit 4. The modulated images are thereafter provided in the form of a stream F′ to a display device 5 with its screen 6. An image memory 6 is designed to apply a lag to the sequence of images provided to the modulation circuit 4 so that the latter simultaneously receives the video data of the images of the sequence and the zone of interest information relating thereto.

The detection of zones of interest in a sequence of source images consists for example in generating saliency maps of the sequence. This generation has already formed the subject of several patent applications including international application WO 2005/059832 and of several articles such as “From low level perception to high level perception, a coherent approach for visual attention modeling” by O. Le Meur, P. Le Callet, D. Barba, D. Thoreau, and E. Francois, Proc. SPIE Human Vision and Electronic Imaging IX (HVEI'04), San Jose, Calif., (B. Rogowitz, T. N. Pappas Ed.), January 2004, “Bottom-up attention modeling: quantitative comparison of predicted saliency maps with observers eye-tracking data” by O. Le Meur, P. Le Callet, D. Barba and D. Thoreau, ECVP 2004, Budapest, Hungary, August 2004 and “A human visual model-based approach of the visual attention and evaluation performance” by O. Le Meur, P. Le Callet, D. Barba and D. Thoreau, Proc. SPIE Human Vision and Electronic Imaging X (HVEI'05), San Jose, Calif., (B. Rogowitz, T. N. Pappas Ed.), January 2005. The content of these documents should be regarded as forming part of the present patent application.

The generation of saliency maps, such as described in these documents, is recalled briefly hereafter. The schematic of the proposed steps is presented in FIG. 5. It comprises at one and the same time steps of spatial modelling and steps of temporal modelling of visual attention.

The spatial modelling of visual attention is composed of three sequential parts. The role of the first part 100 is to model the fact that our visual system does not assess the visual components of our environment in the same way. This limited sensitivity is simulated by the use of contrast sensitivity functions CSFs and the use of an intra and inter component visual masking. These functions are applied to the components (A, Cr1, Cr2) of the Krauskopf antagonistic colour space, that were previously deduced from the RGB components of the image signal. A hierachical decomposition into perceptual channels, denoted DCP, simulates the frequency tiling of the visual system. On the basis of the frequency spectrum, a set of sub-bands having a range of radial frequencies and a particular angular selectivity is defined. Each sub-band can in fact be regarded as the neuronal image delivered by a population of visual cells reacting to a particular frequency and to a particular orientation.

The second part 200 relates to the visual perception mechanism. The latter makes it possible to extract the visual characteristics transporting significant information so as to create an economic representation of our environment. The organization of the receptor fields of the visual cells, be they retinal or cortical, fully meets this requirement. They are circular, with a preferred direction for the cortical cells, and consist of a centre and of a rim having antagonistic responses. This organization therefore accords them the property of responding strongly as regards contrasts and of not responding as regards the uniform zones. The modelling of cells of this type is performed via differences of Gaussians (denoted hereafter DoG) oriented or non-oriented. Thus, the sub-bands originating from the three components are convolved with an operator much like a DoG. Perception consists also in accentuating certain characteristics essential for the interpretation of information. By following the principles of the Gestaltist school, a butterfly filter is applied so as to strengthen the co-linear contours, aligned and of weak curvature. The Gestaltian principles of good continuity and of co-linearity are therefore used.

Finally, so as to construct the spatial saliency map, a merging of the various components 300 is performed by grouping or linking a-priori independent elements to form a structure comprehensible to the brain. The merging is based on an intra component and inter component competition making it possible to use the complementarity and the redundancy of the information carried by various visual dimensions (achromatic or chromatic).

A spatial saliency map is thus generated for each of the images of the sequence. An example of a spatial saliency map is given in FIGS. 6A to 6C. FIG. 6A represents the source image, FIG. 6B represents the associated spatial saliency map and FIG. 6C represents the associated spatial saliency map if the source image is processed per macroblock.

A temporal modelling of the visual attention is carried out in parallel on the images of the sequence. In a moving context, the contrasts of motion are certainly the most significant visual attractors. It is clear that an object travelling over a static background, or reciprocally a static object on a moving background, attracts our visual attention. To determine these contrasts, the consideration of the ocular tracking motions is paramount. These ocular motions make it possible to compensate naturally for the displacement of an object. The velocity of the motion considered, expressed in the retinal reference frame, is then almost zero. To determine the most pertinent contrasts of motion, it is consequently necessary to compensate for the inherent motion of the camera, assumed dominant. On the basis of a vector field generated by a motion estimation 400 based on the hierachical decomposition of the images into perceptual channels, a complete affine parametric model is calculated by virtue of a robust estimation technique 500 based on M-estimators. The retinal motion 600 corresponding to the difference between the local motion and the dominant motion is thus calculated. The larger this value (taking into account all the same the theoretical maximum velocity of the ocular tracking motion) the more the zone in question attracts the gaze. The temporal saliency is thereafter deduced simply from this retinal motion. Note that, given that it is easier to detect a moving object among static distractors than the converse, the retinal motion is modulated by the overall amount of motion of the scene.

A merging of the maps of spatial and temporal saliency 700 involving an intra and inter map competition mechanism is thereafter performed.

A temporal recurrence is advantageously applied to the successive maps of spatio-temporal saliency so as to extract and to validate over several images the so-called zones of interest (zones of the image having a saliency value greater than or equal to a predetermined threshold) and the so-called zones of “non-interest” (zones of the image having a saliency value less than a predetermined threshold).

The zones of interest and of non-interest of the sequence of images can be deduced from these maps by applying a step of thresholding. This is illustrated by FIG. 7 within the framework of the second embodiment. The zones having a saliency value less than a predefined threshold value are regarded as zones of non-interest and all the other are regarded as zones of interest. Advantageously, a low-pass filter smooths the local fluctuations of the saliency.

As a variant, it is possible to envisage a step of thresholding with several thresholds so as to generate a modulation image with more than two modulation amplitude levels. Intervals of saliency values are then defined between each pair of consecutive threshold values. A modulation amplitude value is then associated with each of these intervals.

Advantageously, the method of the invention is supplemented with a step of estimation of the motion 30 in the images of the said sequence, as illustrated in FIG. 8, so as to motion compensate the pattern according to the estimated motion and reduce the possible hindrance introduced by possible poor temporal integration of the pattern in a moving scene.

As a variant, instead of estimating the motion in the sequence of images, it is possible to envisage detecting the static zones of the sequence of images then selecting the pixels to be modulated temporally from among the pixels of the static zones detected.

Of course, the invention is not limited to the embodiments described above. In particular, the person skilled in the art will be able to perform a temporal modulation of the chrominance of the pixels of the image sequence. He will also be able to perform a temporal modulation at one and the same time of the chrominance and of the luminance of the pixels of the sequence of images.

Moreover, the detection of zones of interest can optionally be performed by known means other than the generation of saliency maps.

1. Method of image processing intended to display at least one anti-copy pattern in a sequence of source images, each source image comprising a plurality of pixels arranged in rows and columns and the said pattern comprising a set of pixels selected from the said image, each pixel having a predetermined video information item in each of the source images, the said method comprising a step of modulation for temporally modulating the video information of each pixel of the pattern around its predetermined video information so as to be invisible to the human eye and create artefacts when the said images are copied by filming during their display,
wherein, prior to the said step of modulation, it furthermore comprises a step of detection of the zones of interest in the sequence of source images and wherein the amplitude of the modulation of the video information of a pixel of the pattern around its predetermined video information is adjusted as a function of the membership of the said pixel in a zone of interest.

2. Method according to claim 1, wherein the amplitude of the temporal modulation is larger for the pixels of the pattern not belonging to a zone of interest of the sequence of source images than for the pixels of the pattern belonging to a zone of interest.

3. Method according to claim 1, wherein the amplitude of the temporal modulation is lower for the pixels of the pattern not belonging to a zone of interest of the sequence of source images than for the pixels of the pattern belonging to a zone of interest.

4. Method according to claim 3, wherein the amplitude of the modulation of the pixels of the pattern belonging to the zones of non-interest decreases as the distance separating the pixels to be modulated and a zone of interest increases.

5. Method according to claim 1, wherein, prior to the said step of modulation, it furthermore comprises a step of estimation of the motion in the images of the said sequence and wherein the pattern is motion compensated according to the estimated motion.

6. Method according to claim 1, wherein, prior to the said step of modulation, it furthermore comprises a step of detection of the static zones in the sequence of source images and wherein the temporally modulated pixels are selected from among the pixels of the static zones detected.

7. Method according to claim 1, wherein the said video information is the luminance and/or the chrominance of the pixel.

8. Device for image processing intended to display at least one anti-copy pattern in a sequence of source images, each source image comprising a plurality of pixels arranged in rows and columns and the said pattern comprising a set of pixels selected from the said image, each pixel having a predetermined video information item in each of the source images, the said device comprising a modulation circuit for temporally modulating the video information of each pixel of the pattern around its predetermined video information so as to be invisible to the human eye and create artefacts when the said images are copied by filming during their display,
wherein it furthermore comprises a circuit for detecting the zones of interest in the sequence of source images and wherein the modulation circuit modulates the video information of the pixels of the pattern with an amplitude which depends on the membership of the said pixels in a zone of interest.
